(19) United States
(12) Patent Application Publication
(10) Pub. No.: US 2003/0078802 A1
(43) Pub. Date: Apr. 24, 2003

(54) Method, system and program for creating a delivery plan

(75) Inventor: Takashi Yonezawa, Yamato-shi (JP)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/265,754

(22) Filed: Oct. 7, 2002

(30) Foreign Application Priority Data
Oct. 22, 2001 (JP) 2001-323549

(51) Int. Cl. G06F 17/60

(52) U.S. Cl. 705/1; 705/7

(57) ABSTRACT

Where a plurality of delivery vehicles must start at a product distribution center, deliver products to one or more destinations on a route and then return the distribution center, a delivery plan is used to minimize operating costs. Possible delivery plans, having a plurality of delivery routes, are established. Plan evaluation values are established by accumulating the travel times for each route in the plan. The travel time for each route is the sum of the actual inter-destination travel times and weighted travel times for the initial (distribution center to first destination) and final (last destination to distribution center) segments of the route. The weighting reduces the effect of the initial and final segments relative to the effect of the inter-destination travel times. The evaluation values are compared in a series of iterations until it is determined that no further improvement can be obtained in evaluation value.

### FIELD OF THE INVENTION

The present invention relates to a technique for creating a delivery plan in a logistics system, and more particularly to a technique for creating a delivery plan in which a plurality of delivery vehicles start from a distribution center, deliver one or more packages to one or more destinations (delivery destinations) and return to the distribution center.

### BACKGROUND OF THE INVENTION

One of the most important current issues in enterprise management is reducing logistics costs; that is, the cost of distributing products. A large enterprise delivers a large number of packages to various parts of the whole country by using hundreds or thousands of trucks per day. The logistics cost is enormous, and the creation of an efficient delivery plan leading to the reduction of the logistics cost is very important for an enterprise or a transportation company which contracts for delivery.

In the past, delivery plans were created manually by experienced, skilled people. However, it was never easy to find enough people with the necessary skills and the effort to find, train and retain such people was a significant contributor to logistics costs. It is becoming common to automatically create delivery plans using a computer program. Such programs are in great demand.

In general, in a case where a delivery plan is to be created using a computer, certain constraints (for instance, a load limit for each delivery vehicle, a limit to the number of the delivery vehicles, a limit to the total operating time of the delivery vehicles, etc.) exist as conditions. A delivery instance (the positions of delivery destinations, the items and weights of loads to-be-delivered, etc.) is included under the conditions. Also included as a condition is a need to deliver packages in such a way that the delivery vehicles start from a distribution center (the base of the delivery vehicles) and return thereto after making a round of the plurality of destinations (delivery destinations). Optimization is executed by the computer and with an objective function concerning the constraints, the necessary number of the delivery vehicles, the total operating time of the delivery vehicles, etc., whereby the delivery plan satisfying the given conditions is automatically generated.

A program product, which creates a delivery plan satisfying the conditions, through such optimization, is “Vehicle Routing Planner for Windows (R) (hereinbelow, abbreviated to “VRP”)” which is offered by International Business Machines Corporation.

The VRP executes optimization by creating the tentative delivery plan (initial or tentative solution) with a given delivery instance and then executing a local search for the tentative delivery plan, thereby to create the final delivery plan which satisfies conditions. Here, in the “local search”, predefined processing called a “local operation”, by which the topology of the tentative delivery plan is altered, is executed for the tentative delivery plan so as to obtain a new delivery plan (new solution). The new delivery plan resulting from the execution of the local operation is evaluated so as to determine if it has been improved on the tentative delivery plan preceding the local operation. If the new delivery plan has improved on the tentative delivery plan, the local operation is adopted, and the processing is iterated, thereby to obtain a better solution.

According to the local search method, constraints such as the necessary number of delivery vehicles, the total operating time of the delivery vehicles, etc. are dynamically considered, and an optimized delivery plan is obtained. However, unforeseen situations such as the absence of a customer at a delivery destination occur on some occasions. In a case where such an unforeseen situation has occurred in a delivery plan in which destinations extend over a geographically wide range, a longer time can be eventually expended on the actual delivery though the constraints, the necessary number of the delivery vehicles, the total operating time of the delivery vehicles, etc. are optimized on the original delivery plan.

More specifically, in a case where a package cannot be delivered due to the absence of a customer at a certain delivery destination, a delivery vehicle needs to return to the delivery destination and deliver the package after it has delivered packages to other delivery destinations. When the delivery destinations extend over a geographically wide range, a time period required for returning to the delivery destination where the customer was absent becomes long. It is accordingly desired to form a delivery plan so that delivery destinations may lie within a narrow geographical distribution range.

An “area division method” for solving this problem is disclosed in Japanese Patent Laid-Open No. 311702/1997. The area division method divides a delivery area into blocks on the basis of the data of past delivery instances and allocates a plurality of vehicles to each divisional block. Regarding a given delivery instance, the vehicles are tentatively allocated by forming delivery plans for the respective blocks. Thereafter, adjustments are made among the blocks so as to finally determine an optimal delivery plan.

With the area division method, however, the blocks are originally the predetermined fixed ones, and delivery destinations cannot be dynamically grouped. Even if the adjustments are made among the blocks after the tentative allocation of the vehicles, this method is sometimes unsatisfactory from the viewpoint of creating a flexible delivery plan.

As a result, the application of the area division method sometimes creates an inefficient, inflexible and non-versatile plan. By way of instance, a situation where the delivery vehicles are allocated to a block having low delivery requirements, depending upon the contents of the delivery instance and how to divide the area into the blocks. Moreover, a situation can occur where two successive destinations are quite far apart even though in the same block, and where the delivery of a package by the delivery vehicle allocated to an adjacent block would clearly more efficient than using a delivery vehicle within the block containing the destinations.

### SUMMARY OF THE INVENTION

The present invention is a method, a system and a computer program for narrowing the geographical distribution range of delivery destinations assigned to respective delivery vehicles through an improvement in the local search method.

The present invention, implemented in a computer system including a processor and memory means, includes the steps of: (1) generating a tentative delivery plan from given data of delivery instance stored in the memory means; (2) calculating an evaluation value for the tentative delivery plan; (3) executing an operation altering the topology of the tentative delivery plan to generate a new delivery plan; (4) calculating an evaluation value of the new delivery plan; (5) comparing the evaluation value of the tentative delivery plan and that of the new delivery plan; (6) replacing the tentative delivery plan with the new delivery plan where the evaluation value of the new delivery plan is better than that of the tentative delivery plan; and (7) outputting the selected delivery plan.

In the above method, a total operating time of the delivery vehicle is one of the factors of the evaluation value; and each of the steps (2) and (4) of calculating the evaluation values includes the steps of: determining a travel time from the distribution center to the first destination for each of the delivery routes included in the delivery plan; multiplying the travel time from the distribution center to the first destination by a first coefficient k₁ (0<k₁<1) to calculate a first value, for each of the delivery routes included in the delivery plan; determining a travel time from the last destination to the distribution center for each of the delivery routes included in the delivery plan; multiplying the travel time from the last destination to the distribution center by a second coefficient k₂ (0<k₂<1) to calculate a second value, for each of the delivery routes included in the delivery plan; and calculating the total operating time of the plurality of delivery vehicles as one of the factors of the evaluation value by using the first and second values.

### BRIEF DESCRIPTION OF THE DRAWINGS

FIG. 1 shows a hardware architecture for one embodiment of a delivery plan creation system according to the present invention.

FIG. 2 is a functional block diagram of an instance of the embodiment of the delivery plan creation system according to the present invention.

FIG. 3 is a flow chart showing an instance of the flow of processing in the embodiment of the present invention.

FIG. 4 is a flow chart showing the contents of the processing of the calculation of the evaluation value of a delivery plan in the processing flow in the embodiment of the present invention.

FIG. 5 shows a delivery plan created by applying a prior-art local search method to a certain delivery plan.

FIG. 6 shows a delivery plan created by applying the present invention to the same delivery instance as in FIG. 5

FIG. 7 shows an instance (“2-Opt local operation”) of a local operation in the embodiment of the present invention.

FIG. 8 shows an instance (“ladder local operation”) of the local operation in the embodiment of the present invention.

FIG. 9 shows an instance (“path shifting local operation”) of the local operation in the embodiment of the present invention.

FIG. 10 shows an instance (“path exchanging local operation”) of the local operation in the embodiment of the present invention.

### DESCRIPTION OF PREFERRED EMBODIMENT

An embodiment of the present invention will be described in detail with reference to the drawings. The present invention, however, can be performed in a large number of different aspects and shall not be construed as being restricted to the stated contents of the embodiment. The same reference numerals are assigned to the same constituents throughout the embodiment.

In this embodiment, a method or a system will be mainly described, but as obvious to those skilled in the art, the present invention can be performed as a program usable in a computer. Accordingly, the present invention can be embodied as hardware, software, or a combination of software and hardware. The program can be recorded in any desired computer-readable medium such as a hard disk, CD-ROM, optical storage device or magnetic storage device.

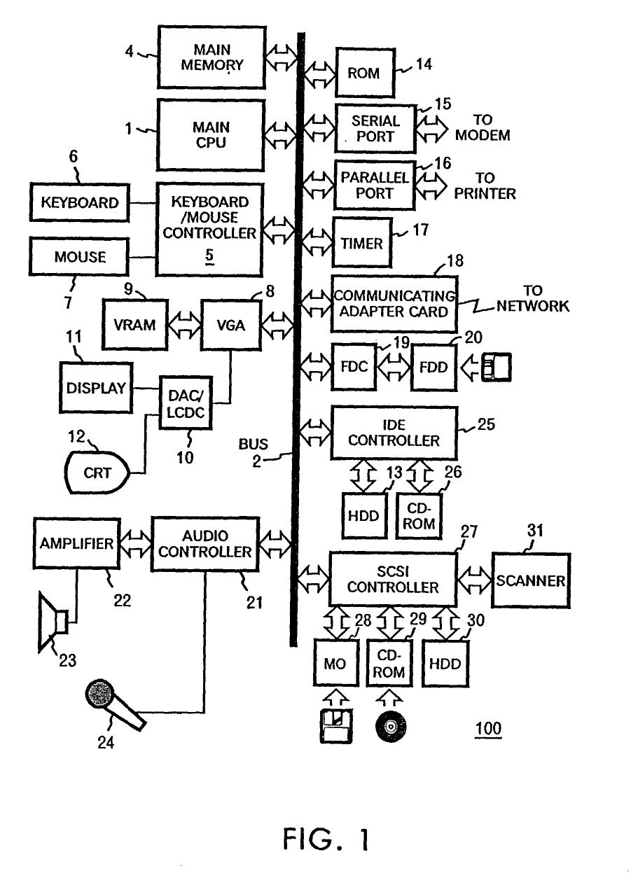

Shown in FIG. 1 is an embodiment of the typical hardware architecture of a computer system in which the present invention is performed. The computer system 100 includes a central processing unit (CPU) 1 which is a so-called “processor”, and a main memory 4 which serves as memory means. The CPU 1 and the main memory 4 are connected through a bus 2 to a hard disk drive 13 serving as an auxiliary storage device. Also, removable storage systems (external storage systems capable of exchanging recording media), such as a flexible disk drive 20, an magnetic disk drive 28 and CD-ROM drives 26, 29, are connected to the bus 2 through a flexible disk controller 19, an IDE controller 25 and a SCSI controller 27 associated therewith. The storage media such as a flexible disk, an MO and CD-ROMs are respectively inserted into the removable storages such as the flexible disk drive 20, the MO drive 28 and the CD-ROM drives 26, 29. The codes of a computer program for giving instructions to the CPU etc. in cooperation with an operating system so as to perform the present invention can be recorded in the flexible disk etc., the hard disk drive 13 and a ROM 14. The computer program is loaded into the main memory 4 to be executed. This computer program can also be recorded in the plurality of media in a state where it is compressed or where it is divided into a plurality of parts.

The computer system 100 can further include a mouse or the like pointing device 7, a keyboard 6, and a display 12 for presenting visual data to a user, as user interface hardware elements. Besides, the computer system 100 can be connected to a printer (not shown) through a parallel port 16 or to a modem (not shown) through a serial port 15. This computer system 100 can communicate with another computer or the like when connected to a network through the serial port 15 as well as the modem, or through a communicating adapter 18 (Ethernet (R) card or token ring card) or the like. A loudspeaker 23 receives through an amplifier 22 an audio signal subjected to D/A conversion (digital-to-analog conversion) by an audio controller 21, and outputs the received signal as voice. Besides, the audio controller 21 subjects audio information received from a microphone 24, to A/D conversion (analog-to-digital conversion), whereby the audio information outside the system is permitted to be accepted into the system.

It will be understood from the above description that the computer system 100 of the present invention can be embodied by any information processing apparatus, such as ordinary personal computer (PC), workstation, laptop PC, notebook PC, palmtop PC or network computer, or the combination of such information processing apparatus. A number of the elements are described as examples of a typical system. Not all of them are necessary to the present invention. In particular, the removable storage systems, the printer, the modem and the audio elements can be omitted from the hardware architecture described here without affecting an implementation of the invention.

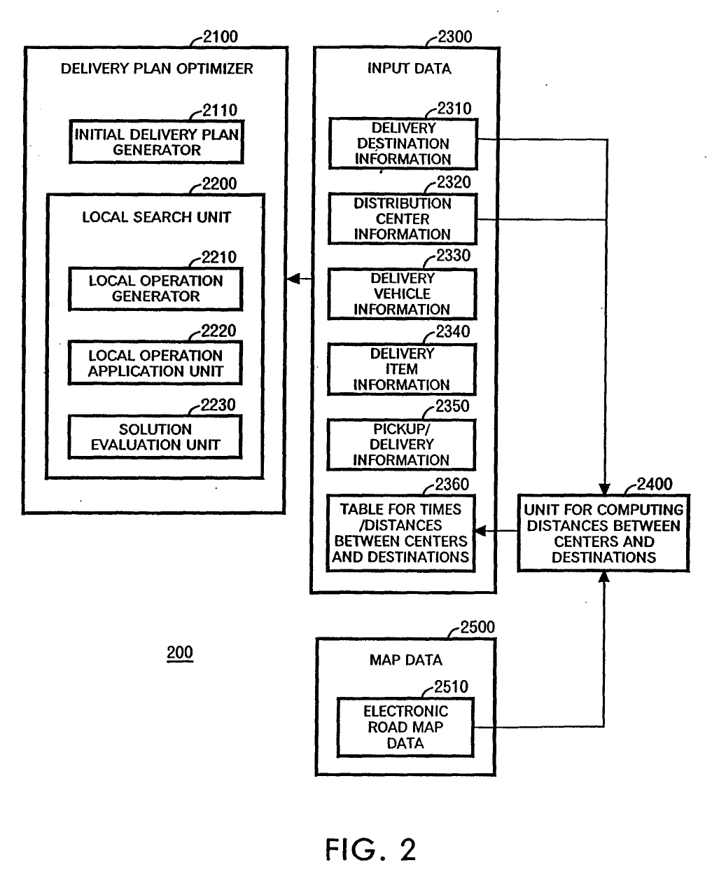

FIG. 2 is a functional block diagram of an instance of the embodiment of a delivery plan creation system according to the present invention. Various elements shown in the functional block diagram are embodied by the cooperation of hardware and software on the computer system shown in FIG. 1 by way of instance. Referring to FIG. 2, the system 200 of this embodiment includes a delivery plan optimizer 2100, which includes an initial delivery plan generator 2110. The optimizer 2100 further includes a local search unit 2200. The local search unit 2200 includes a local operation generator 2210, a local operation application unit 2220 and a delivery plan evaluation unit 2230.

Also referring to FIG. 2, it is understood that delivery destination information 2310, distribution center information 2320, delivery vehicle information 2330, delivery item information 2340 and pickup/delivery information 2350 are contained as input data 2300 in the system 200 of this embodiment. Further, the system 200 of this embodiment has a table for the times/distances between distribution centers and delivery destinations 2360 which have been generated from the delivery destination information 2310, the distribution center information 2320, and electronic road map data 2510 contained in map data 2500, by the use of a unit for computing distances between the distribution centers and the delivery destinations, 2400.

The delivery destination information 2310 contains the information of the latitudes/longitudes, names and addresses of the delivery destinations. The distribution center information 2320 contains the information of the latitudes/longitudes, appellations, addresses and deliverable time zones of the distribution centers which are the start points and end points of deliveries by delivery vehicles. The delivery vehicle information 2330 can contain information on the delivery vehicles, specifically, the information on maximum vehicle loads, and the costs and deliverable items of the individual vehicles. The delivery item information 2340 can contain information on the carrying loads (weights and sizes) of delivery items to be delivered. The pickup/delivery information 2350 contains information for managing pickups/deliveries, specifically, delivery items to be picked up/delivered and the quantities of the respective items are defined. The electronic road map data 2510 should appropriately contain the geographical information of roads and the mean speed information of the respective roads. Stored in a table format in the time/distance table 2360 are the travel times between the places and between the distribution centers as have been calculated from the latitudes/longitudes of the places contained in the place information 2310, the latitudes/longitudes of the distribution centers contained in the distribution center information 2320, the geographical information of the roads and the mean speed information of the respective roads contained in the electronic road map data 2510, and so forth.

The initial delivery plan generator 2110 generates a tentative delivery plan (initial solution) on the basis of the input data 2300. The local search unit 2200 generates, from the tentative delivery plan, a local operation for altering the topology (the sequence in which the individual delivery vehicles are to visit the destinations) of the tentative delivery plan, and evaluates the local operation and the delivery plan (as described in detail later), to execute optimization and to output a final delivery plan satisfying constraint conditions.

The local search unit 2200 includes the local operation generator 2210, the local operation application unit 2220 and the delivery plan evaluation unit 2230. The local operation generator 2210 generates the local operation applied to the tentative delivery plan. The local operation application unit 2220 executes the local operation for the tentative delivery plan. The delivery plan evaluation unit 2230 evaluates delivery plans by the use of an objective function such as the total operating time of the delivery vehicles, etc.

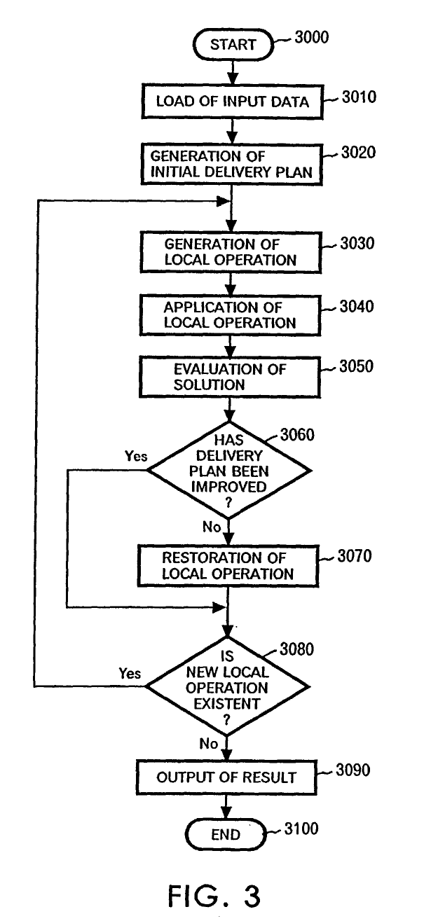

FIG. 3 is a flow chart showing an instance of the flow of processing in the embodiment of the present invention.

In the embodiment of the present invention, the processing is started from a step 3000, and input data which contain the information of a delivery instance, such as delivery destination information, distribution center information and delivery vehicle information, are loaded into a main memory at a step 3010, and the processing proceeds to a step 3020. At the step 3020, the initial delivery plan generator 2110 generates an initial delivery plan to which a local operation is to be applied, on the basis of the input data derived from the main memory and using a CPU, and it stores the initial delivery plan in the main memory. The initial delivery plan can be created, for instance, by generating a suitable number of routes in which delivery vehicles start from the distribution center, visit proper delivery destinations clockwise and lastly return to the distribution center.

Subsequently, the processing proceeds to a step 3030, at which the local operation to be executed for the tentative delivery plan is generated by the local operation generator 2210. The local operation may be generated by defining sets each of which consists of a destination, and other destinations belonging to a range for the local operation of the particular destination (for instance, a circle having a predetermined radius about the particular destination may be set as the range), and then selecting the local operation which is to be executed for the set.

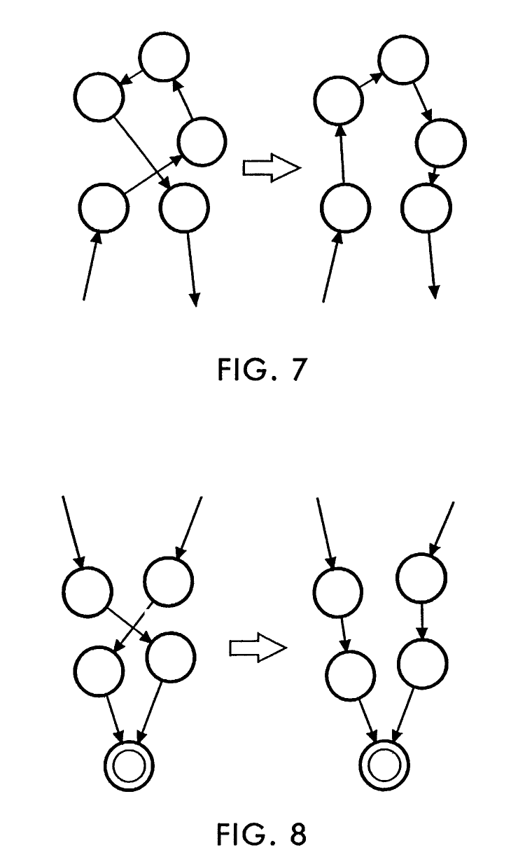

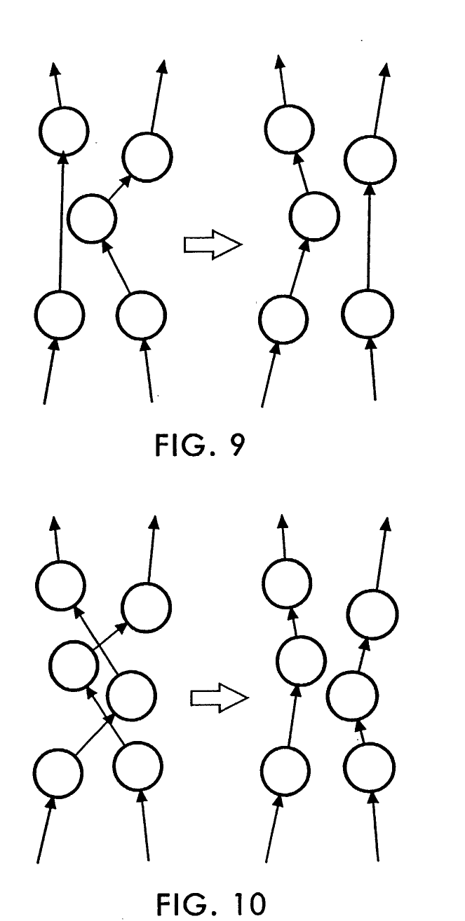

Considered as such local operations are a “2-Opt local operation” which eliminates the twisted state of the route of the delivery vehicle (FIG. 7), a “ladder local operation” in which the certain destination, et seq. of a certain route are exchanged for the certain destination, et seq. of another route (FIG. 8), a “path shifting local operation” in which a destination (or a plurality of successive destinations) on a certain route is assigned onto another route (FIG. 9), and a “path exchanging local operation” in which a destination (or a plurality of successive destinations) on a certain route is exchanged for a destination (or a plurality of successive destinations) on another route (FIG. 10). In FIGS. 7 through 10, an arrow indicates the route between the distribution center and the destination or between the destinations, a single circle represents the destination, and a double circle represents the distribution center.

Although the four types of local operations have been briefly introduced above, they shall not be described in more detail for the reasons that the contents of the local operations are not essential to the present invention in themselves, and that those skilled in the art can properly design and realize different variations.

At a step 3040, the local operation is executed using the CPU, whereby the new delivery plan is generated and is stored in the main memory. Subsequently, at a step 3050, the evaluation value of the new delivery plan, which is derived from the main memory, is calculated using the CPU. By the way, in the first loop, the evaluation value of the initial delivery plan may well be calculated on this occasion. The calculation of the evaluation value of the delivery plan at the step 3050 will be detailed later.

Subsequently, at a step 3060, it is determined whether the evaluation value obtained at the step 3050 has been improved as compared with the evaluation of the delivery plan previous to the local operation. Subject to the determination of the step 3060 that the evaluation value has not been improved, the local operation is restored at a step 3070, and the processing proceeds to a step 3080. Subject to the determination of the step 3060 that the evaluation value has been improved, the processing immediately proceeds to the step 3080.

Regarding the determination on the improvement at the step 3060, consider a case where the variables of an objective function are the violations of constraints (such as the load limits of delivery vehicles), the number of the necessary delivery vehicles, and the total operating time of the delivery vehicles. In such a case, a delivery plan which affords a smaller number in the constraint violations may be decided to be better. When the numbers of the constraint violations are equal, a delivery plan which affords a smaller number in the necessary delivery vehicles may be determined better. When the numbers of the constraint violations and the numbers of the necessary delivery vehicles are equal, a delivery plan which provides the lowest total operating time of the delivery vehicles may be decided better.

At a step 3080, it is determined if a new local operation to be executed for the tentative delivery plan exists. In a case where the new local exists and where the local operation can be generated anew, the processing returns to the step 3030, at which the new local operation is generated, whereupon the processing steps 3040 through 3080 stated above are executed.

This loop is iterated until the determination of the step 3080 that a new local operation does not exist. As optimization proceeds, the improvement is determined (that is, the tentative delivery plan is substituted) at the step 3060 less frequently, and hence, the new generation of the local operation becomes less frequent.

Subject to the determination of the step 3080 that the new local operation to be executed for the tentative delivery plan does not exist, the processing proceeds to a step 3090, at which the tentative delivery plan is retrieved from the main memory and outputted. Processing ends at a step 3100.

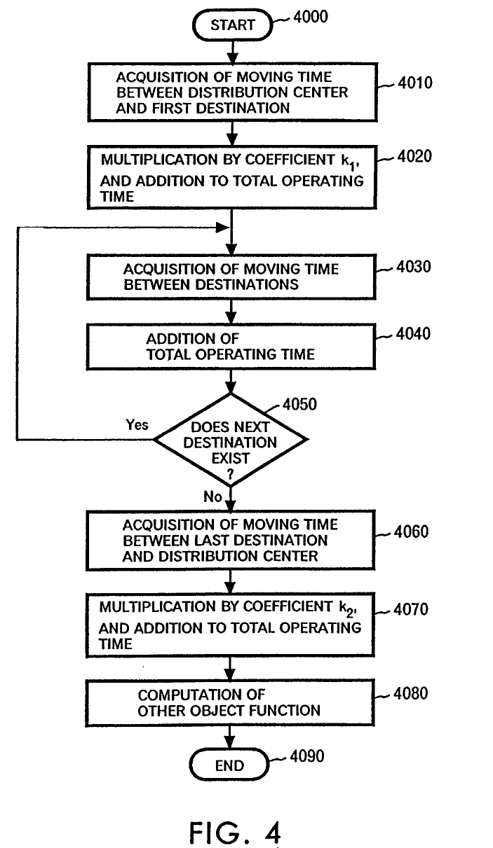

For better understanding of the present invention, the details of the calculation of the evaluation value of the delivery plan at the step 3050 will be described in conjunction with the flow chart of FIG. 4.

The calculation of the evaluation value begins at step 4000. At a step 4010, a travel time from the distribution center to the first destination (first delivery destination) is acquired for each delivery vehicle. The times/distances between the distribution centers and the first destinations of the respective routes which are held in the table 2360 prepared beforehand and stored in the main memory.

Subsequently, the processing proceeds to a step 4020, at which the travel time from the distribution center to the first destination acquired at the step 4010 is multiplied by a coefficient k₁ (0<k₁<1) using the CPU, and the resulting time is added to the total operating time of the delivery vehicle of each route, whereupon the processing proceeds to a step 4030. Herein, a stop time for the first destination (the time the delivery vehicle is expected to remain at the first destination) may be added to the total operating time.

At the steps 4030 through 4050, the travel time between the successive destinations on each route is added to the total operating time of the delivery vehicle. More specifically, the travel time from the first destination to the second destination is acquired at the step 4030, and is added to the total operating time at the step 4040. Herein, a stop time at the second destination may be added to the total operating time. As at the step 4010, the travel time between the destinations may be acquired by reference to table 2360. At the subsequent step 4050, if another destination exists, the processing returns to the step 4030. These processing steps are iterated until the addition of a travel time from the penultimate destination to the last destination and a stop time in the penultimate destination. The processing then proceeds to a step 4060.

At the step 4060, the travel time between the last destination of each route and the distribution center is acquired. As at the step 4010, the travel time may be acquired by reference to the table 2360.

Subsequently, the processing proceeds to a step 4070, at which the travel time between the last destination of each route and the distribution center is multiplied by a coefficient k₂ (0<k₂<1) and the resulting time is added to the total operating time of the delivery vehicle of each route. The value of the coefficient k₂ may or may not be the same as the value of the adjustment coefficient k₁ used at the step 4020.

After the execution of the processing step 4070, the processing proceeds to a step 4080, at which another objective function of constraints, the number of the necessary delivery vehicles or the like, is computed using the CPU. Thereafter, the processing proceeds to a step 4090, at which the evaluation of the delivery plan is ended.

It is understood from the above description that the objective function concerning the total operating time in this embodiment is given as follows:

$$\begin{matrix}T = {\sum }_{t = 1}^{N} {T}_{t} \\ {T}_{t} = {k}_{1} {d}_{01} + {\sum }_{i = 1}^{n - 1} {d}_{i + j + 1} + {k}_{2} {d}_{nn + 1} + {\sum }_{i = 1}^{n} {s}_{i}\end{matrix}$$

where

T: Total operating time of Delivery vehicles

The number of the delivery vehicles is assumed to be N.

Tₜ: Operating time of the t-th delivery vehicle

k₁, k₂: coefficients

dᵢⱼ: Travel time between i-th and j-th destinations

The number of the places included in a route is assumed to be n.

The O-th and (n+1)th places are indicated to be a distribution center.

Sᵢ: Stop time in the i-th place.

It is understood that the coefficients k1, k2 reduce the weight of the travel time between the distribution center and the first and the last stops on the route as compared with the travel time between successive destinations within the route.

In a case where the total operating times of the delivery vehicle without any weighting by coefficients are equal before and after the local operation, the delivery plan in which the travel times of the delivery vehicle between the in-route destinations is shorter and the actual travel times between the distribution center and the first and last stops is considered to be the better of the two plans.

Incidentally, for the purpose of permitting a user to designate how the geographical distribution of destinations is laid out, the user should have the ability to modify coefficients k1 and k2.

Incidentally, the total operating time of the delivery vehicle used as the evaluation value in this embodiment is modified by applying the coefficients to the travel time from the distribution center to the first destination and to the travel time from the last destination back to the distribution center. It is therefore to be noted that the total operating time used is not the “actual” total operating time, but instead an evaluation value.

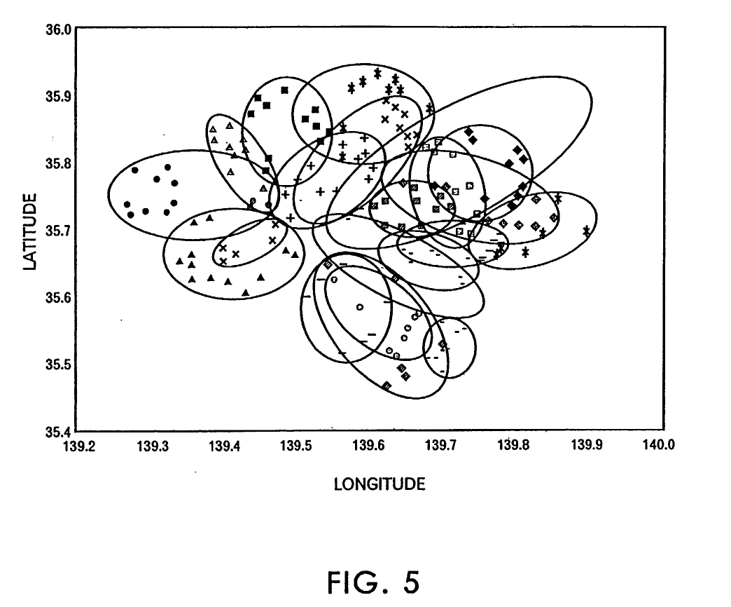

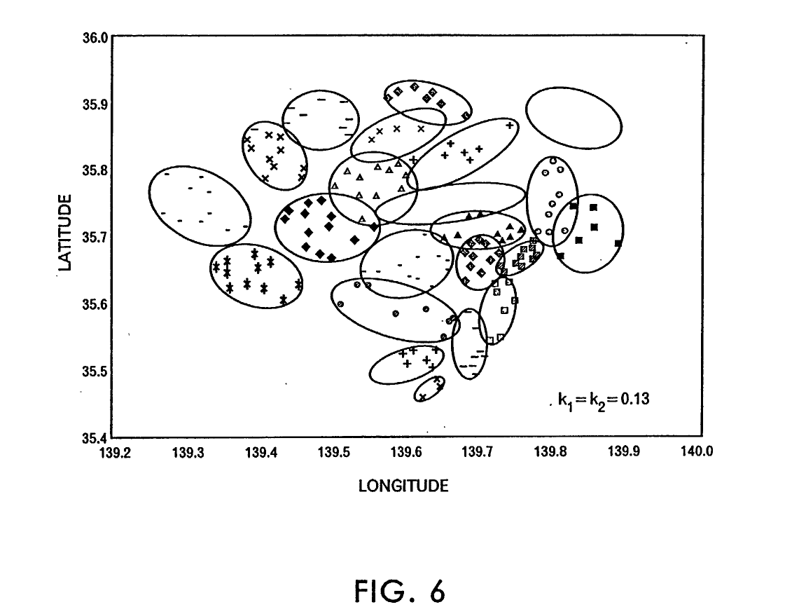

A delivery plan created for a certain delivery instance by the prior-art local search method (in the state where k1=k2=1) is shown in FIG. 5. A delivery plan created for the identical delivery instance by the local search method in accordance with the present invention is shown in FIG. 6. In creating the delivery plan shown in FIG. 6, the coefficients were k1=k2=0.13. Dots expressive of the destinations are indicated in shapes which are different for the respective delivery vehicles. The destinations assigned to each of the delivery vehicles are surrounded with an ellipse. As seen from FIGS. 5 and 6, the shape of each ellipse (that is, the geographical range of the destinations for which each delivery vehicle) is smaller in the case of FIG. 6 than in the case of FIG. 5. It is accordingly understood that the geographical range of the destinations for each delivery vehicle can be narrowed by applying the present invention.

The above embodiment of the present invention is intended for the purpose of illustration only. While the described emobidment deals with the creation of delivery plans, those skilled in the art will recognize that the present invention is applicable to many other fields, for instance, the routing of buses, the delivery of mail or newspaper, the collection of garbage, and the delivery of fuel.

What is claimed is:

1. For use in a computer system including a processor and a memory, a method for creating a delivery plan including delivery routes for each of a plurality of delivery vehicles, each route starting at a distribution center, including one or more sequential delivery destinations and end with a return to the distribution center, a computer-implemented method comprising the steps of:
(1) generating a tentative delivery plan using data of delivery instances stored in the memory;
(2) calculating an evaluation value for the tentative delivery plan;
(3) executing an operation that alters the topology of the tentative delivery plan to generate a new delivery plan;
(4) calculating an evaluation value for the new delivery plan;
(5) comparing the evaluation value of the tentative delivery plan to the evaluation value of the new delivery plan;
(6) where the evaluation value of the new delivery plan is superior, substituting the new delivery plan for the tentative delivery plan; and
(7) causing the processor to output the selected delivery plan,
wherein the evaluation value for a delivery plan is based on the accumulated delivery times for the delivery routes included in the plan, and
each of the steps (2) and (4) of calculating the evaluation values further including the steps of, for each route in the delivery plan,
establishing a first travel time from the distribution center to the first destination on the route,
modifying the established travel time by a coefficient k₁ to calculate a first value,
establishing a second travel time from the last destination to the distribution center for,
modifying a second travel time by a coefficient k₂ to calculate a second value, and
using the modified travel times and the actual inter-destination delivery times in calculating the evaluation value for each route in the delivery.

2. The method as defined in claim 1 further including the steps of reiterating steps (1) through (6) until it is determined that no further improvements in evaluation values are obtained.

3. The method as defined in claim 2 wherein each of the coefficients k₁ and k₂ has a value between 0 and 1 and the steps of modifying the first and second travel times are performed by modifying the established travel time by the coefficient associated with that travel time.

4. A computer system for creating a delivery plan that includes one or more delivery routes, each route being traveled by a delivery vehicle that starts at a distribution center, makes a delivery to one or more destinations and returns to the distribution center, the computer system comprising:
(1) logic for generating a tentative delivery plan using stored data of a delivery instance;
(2) logic for calculating an evaluation value for the tentative delivery plan;
(3) logic for modifying the topology of the tentative delivery plan to generate a new delivery plan;
(4) logic for calculating an evaluation value of the new delivery plan;
(5) comparison logic for comparing the evaluation value of the tentative delivery plan to that of the new delivery plan;
(6) control for substituting the new delivery plan for the tentative delivery plan when the comparison logic indicates the evaluation value of the new delivery plan is superior; and
(7) means for outputting the selected delivery plan;
wherein a total operating time of the plurality of delivery vehicles is one of the factors of the evaluation value of each delivery plan and the logic for calculating the evaluation value includes
logic for acquiring a first travel time from the distribution center to the first destination on a given route,
logic for modifying the first travel time by a first coefficient k₁,
logic for acquiring a second travel time from the last destination to the distribution center for the given route,
logic for modifying the second travel time by a second coefficient k₂, and
accumulator logic for calculating the total operating time of the route using the modified first and second travel times and the actual inter-destination delivery times for destinations on the route.

5. The computer system as defined in claim 4 further including logic for reiterating the calculation of delivery plans until the comparison logic indicates no further improvements in evaluation values are being obtained.

6. The computer system of claim 5 wherein the each of the coefficients k₁ and k₂ has a value between 0 and 1 and the modifying logic includes logic for multiplying the acquired first and second travel times by the associated coefficient.

7. A computer program for creating a delivery plan that includes a plurality of delivery routes, each route starting at a distribution center, including one or more destinations and ending with a return to the distribution center, the computer program causing a computer system to execute the steps of:
(1) generating a tentative delivery plan using data of delivery instances stored in the memory;
(2) calculating an evaluation value for the tentative delivery plan;
(3) executing an operation that alters the topology of the tentative delivery plan to generate a new delivery plan;
(4) calculating an evaluation value for the new delivery plan;
(5) comparing the evaluation value of the tentative delivery plan to the evaluation value of the new delivery plan;
(6) where the evaluation value of the new delivery plan is superior, substituting the new delivery plan for the tentative delivery plan; and
(7) causing the processor to output the selected delivery plan,
wherein the evaluation value for a delivery plan is based on the accumulated delivery times for the delivery routes included in the plan, and
each of the steps (2) and (4) of calculating the evaluation values further including the steps of, for each route in the delivery plan,
establishing a first travel time from the distribution center to the first destination on the route,
modifying the established travel time by a coefficient k₁ to calculate a first value,
establishing a second travel time from the last destination to the distribution center for,
modifying a second travel time by a coefficient k₂ to calculate a second value, and
using the modified travel times and the actual inter-destination delivery times in calculating the evaluation value for each route in the delivery

8. A computer program as defined in claim 7 wherein the computer program further causes the computer to perform the steps of reiterating steps (1) through (6) until it is determined that no further improvements in evaluation values are obtained.

9. A computer program as defined in claim 8 wherein the each of the coefficients k₁ and k₂ has a value between 0 and 1 and the computer program causes each of the first and second travel times to be modified by multiplication with the coefficient associated with the travel time.
